(19) United States
(12) Patent Application Publication
(10) Pub. No.: US 2006/0079303 A1
(43) Pub. Date: Apr. 13, 2006

(54) Swing hinge device of a portable terminal

(75) Inventor: Sang-Min Lee, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO.,LTD., Suwon-si (KR)

(21) Appl. No.: 11/132,969

(22) Filed: May 19, 2005

(30) Foreign Application Priority Data
Oct. 4, 2004 (KR) 78732/2004

(51) Int. Cl. H04M 1/00

(52) U.S. Cl. 455/575.4; 455/575.3; 455/575.1

(57) ABSTRACT

A swing hinge device of a portable terminal for rotatably coupling a pair of housings included in the portable terminal while maintaining the housings facing each other, includes a hinge housing, a hinge cam received in the hinge housing to perform a linearly reciprocating movement in a longitudinal direction of the hinge housing in accordance with a predetermined elastic force applied to the hinge cam, a hinge shaft received in the hinge housing to face the hinge cam and to be rotatable about a hinge axis extending in the longitudinal direction of the hinge housing, and a housing cap fixed to one end of the hinge housing to confine the hinge cam and the hinge shaft in the hinge housing in a state, in which the hinge shaft is partially protruded from the housing cap. The hinge cam and the hinge shaft are hollow to define a wiring hole extending through the hinge housing in the longitudinal direction of the hinge housing when the housing cap is fixed to the hinge housing.

### PRIORITY

This application claims priority to an application entitled “SWING HINGE DEVICE OF PORTABLE TERMINAL” filed in the Korean Intellectual Property Office on Oct. 4, 2004 and assigned Serial No. 2004-78732, the contents of which are hereby incorporated by reference.

### BACKGROUND OF THE INVENTION

1. Field of the Invention

The present invention relates to a portable terminal, and, more particularly, to a swing hinge device of a portable terminal which couples a pair of housings to be rotatable while being maintained in a state of facing each other.

2. Description of the Related Art

In general, “portable terminals” are electronic appliances, which can provide a function for wireless communications between users or between a user and a service provider. Although mobile communication services using portable terminals were limited to voice communication and short message transmission services in their early stages, such mobile communication services have recently been extended to multimedia services such as online games, video-on-demand (VOD), and data services such as transmission of moving picture files and music files.

Portable terminals are classified into a bar type, a flip type, and a folder type based on their appearance thereof. In the bar-typeportable terminal, a keypad, a transmitter, a display, and a receiver are carried in a single housing. In the flip type portable terminal, input and output units are carried in a single housing, and a flip cover to prevent unintentional operation is mounted to the housing. The flip cover is connected by a hinge to the housing. In the folder type portable terminal, a pair of housings are coupled such that they are rotatable to move away from or toward each other while facing each other. In the folder type portable terminal, elements of input and output units are appropriately distributed in the housings to provide convenience in using the portable terminal. Also, the folder type portable terminal has an advantage in terms of portability because the user can carry the portable terminal in a folded state of the housings.

Recently, additional various types of portable terminals have been developed to meet the diverse tastes of users. For example, a sliding type portable terminal, has a pair of housings linearly movable with respect to each other while facing each other to be opened/closed. A swing-type-portable terminal, has a pair of housings that are rotatable with respect to each other while facing each other to be opened/closed. A rotary-type-portable terminal, includes a folder rotatably coupled to a housing while being pivotable in an unfolded state such that the front and back surfaces of the folder are turned over. Lastly, a combination-type-portable terminaluses both the opening/closing operation of the folder type portable terminal and the opening/closing operation of the swing type portable terminal.

U.S. patent application Ser. No. 10/287,148, filed on Nov. 4, 2002, and entitled “MOBILE TERMINAL AND HINGE DEVICE THEREOF”, which is assigned to the assignee of the present application, discloses a swing type portable terminal with a hinge device. In the disclosed swing type portable terminal, a pair of housings are coupled to be rotatable while facing each other. The disclosed hinge device includes a first hinge base, and a second hinge base having a hinge shaft to extend through a hinge hole formed at the first hinge base to hingably couple the second hinge base to the first hinge base. A fastening means such as an E-ring is fitted around an end of the hinge shaft protruded beyond the hinge hole.

In the conventional swing hinge device used to achieve a swing operation of the above-mentioned swing type portable terminal, the shaft is formed at a body part, and a rotating part is rotatably fitted around the shaft, so that the rotating part is rotatable around the shaft in a state in which friction occurs between the inner peripheral surface of the rotating part and the outer peripheral surface of the shaft. For this reason, a degradation in the stability of the swing operation may frequently occur due to a dimensional deviation generated in the manufacture of the hinge device. Furthermore, although the coupling between the body part and rotating part is achieved using a fastening means such as an E-ring or a snap ring, this fastening means generates friction, thereby reducing lifespan. Although friction may be reduced using a separate washer or the like, it is too inconvenient to make it practical.

### SUMMARY OF THE INVENTION

The present invention has been made in view of the above-mentioned problems, and it is an object of the invention to provide a swing hinge device of a portable terminal which is capable of achieving an improvement in the stability of a swing operation.

It is another object of the invention to provide a swing hinge device of a portable terminal that is easy to assemble and has improved durability.

It is another object of the invention to provide a swing hinge device of a portable terminal in which a drive force to semi-automatically rotate one of the housings included in the portable terminal to a predetermined position is generated when the user rotates the same housing by a predetermined angle.

In accordance with the present invention, these objects are accomplished by providing a swing hinge device of a portable terminal for rotatably coupling a pair of housings included in the portable terminal while maintaining the housings in a state of facing each other, including: a hinge housing; a hinge cam received in the hinge housing to perform a linearly reciprocating movement in a longitudinal direction of the hinge housing in accordance with a predetermined elastic force applied to the hinge cam; a hinge shaft received in the hinge housing to face the hinge cam and to be rotatable about a hinge axis extending in the longitudinal direction of the hinge housing; and a housing cap fixed to one end of the hinge housing to confine the hinge cam and the hinge shaft in the hinge housing in a state, in which the hinge shaft is partially protruded from the housing cap, the hinge cam and the hinge shaft being hollow to define a wiring hole extending throughout the hinge housing in the longitudinal direction of the hinge housing in a state, in which the housing cap is fixed to the hinge housing.

### BRIEF DESCRIPTION OF THE DRAWINGS

The above objects and advantages of the present invention will become more apparent by describing in detail preferred embodiments thereof with reference to the attached drawings in which:

FIG. 1 is an exploded perspective view illustrating a swing hinge device of a portable terminal according to an exemplary embodiment of the present invention;

FIG. 2 is an assembled perspective view of the swing hinge device shown in FIG. 1;

FIG. 3 is a partially-broken perspective view of the swing hinge device shown in FIG. 2; and

FIG. 4 is a schematic perspective view explaining an operation of the portable terminal, which is equipped with the swing hinge device of FIG. 1.

### DETAILED DESCRIPTION OF THE PREFERRED EMBODIMENT

Now, preferred embodiments of the present invention will be described in detail with reference to the annexed drawings. In the following description of the present invention, a detailed description of known functions and configurations incorporated herein will be omitted when it may make the subject matter of the present invention unclear.

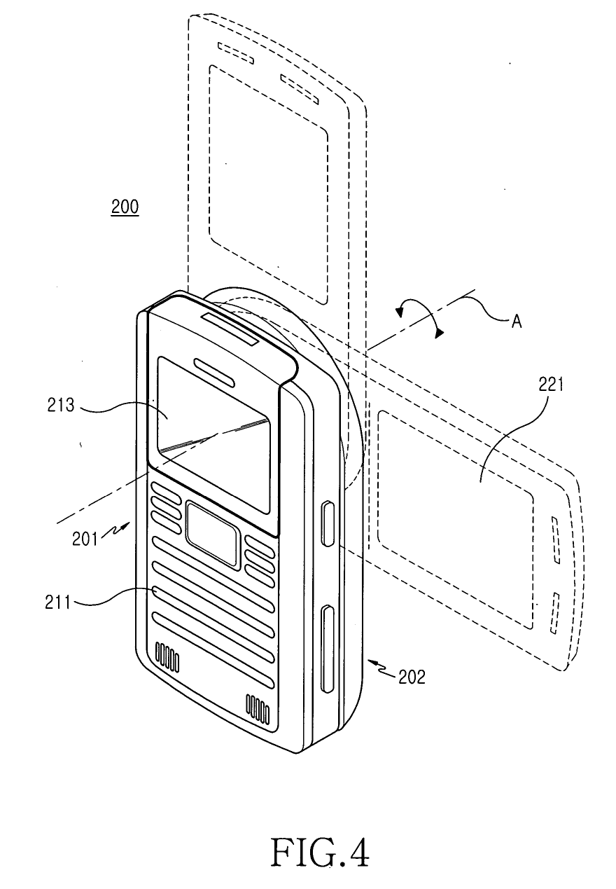

Referring to FIG. 4, a portable terminal, which includes a hinge device according to an exemplary embodiment of the present invention, is illustrated.

The portable terminal, which is designated by reference numeral 200 in FIG. 4, includes first and second housings 201 and 202 rotatably coupled to each other such that the portable terminal 200 is opened/closed in accordance with a rotation of one housing, for example, the housing 202, carried out with respect to the other housing 201 while facing each other. A small-size display 213 and a keypad 211 are attached to a front surface of the first housing 201. The second housing 202 is rotatably mounted to a back surface of the first housing 201, and is provided with a large-size display 221. The second housing 202 is rotatable about a hinge axis A extending perpendicularly from the front surface of the first housing 201 so that the second housing 202 can be opened/closed.

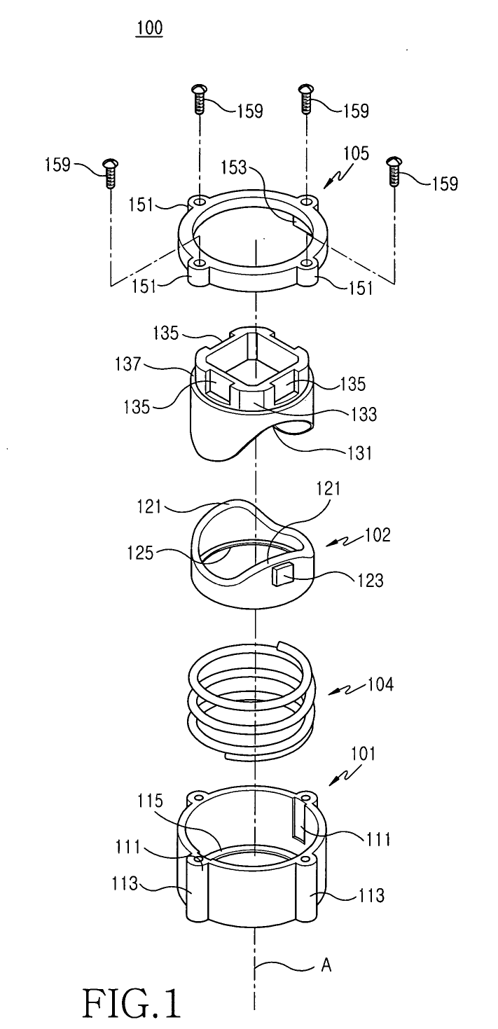

Referring to FIGS. 1 to 3, the hinge device according to the exemplary embodiment of the present invention is illustrated. The hinge device, which is designated by reference numeral 100, includes a hinge housing 101, a hinge cam 102, a hinge shaft 103, an elastic means 104, and a housing cap 105. The elements of the hinge device 100 define an open interior when assembled. A wiring hole extends in a longitudinal direction of the hinge housing 101.

The hinge housing 101 has a longitudinally-extending cylinder structure open at each end. One or more first fastening members 113 are provided on the outer peripheral surface of the hinge housing 101 to extend longitudinally. It is preferred that there be at least two first fastening members 113. In the illustrated case, four first fastening members 113 uniformly spaced apart from one another in a circumferential direction. One or more guide grooves 111 are provided at an inner peripheral surface of the hinge housing 101 to extend longitudinally and downwardly from the upper end of the hinge housing 101. In the illustrated case, a pair of guide grooves 111 are arranged at opposite positions so each of the pairs face each other. A first support rib 115 is provided around the inner peripheral surface of the hinge housing 101, at the lower end of the hinge housing 101.

The hinge cam 102 includes a guide protrusion 123 formed on the outer peripheral surface of the hinge cam 102 to linearly move into one of the guide grooves 111. Accordingly, the hinge cam 102 can perform a linearly reciprocating movement in the hinge housing 101. A cam surface 121 is formed at an upper end of the hinge cam 102. The cam surface 121 has alternating mountain and valley portions. A second support rib 125 to face the first support rib 115 is formed around an inner peripheral surface of the hinge cam 102 at the lower end of the hinge cam 102.

The hinge shaft 103 is rotatably received in the hinge housing 101. A cam surface 131 is formed at the lower end of the hinge shaft 103 so that the cam surface 131 comes into slidable contact with the cam surface 121 of the hinge cam 102. Similarly to the hinge surface 121, the cam surface 131 has alternating mountain and valley portions. A coupling member 133 is provided at the upper end of the hinge shaft 103. The coupling member 133 is provided with one or more coupling grooves 135 formed at an outer peripheral surface of the coupling member 133. The coupling member 133 has an outer diameter less than the outer diameter of the hinge shaft 103, so that a step 137 is defined between the hinge shaft 103 and the coupling member 133.

The hinge housing 101 is mounted to one of the two housings 201 and 202 included in the terminal 200, and the hinge shaft 103 is mounted to the other housing. Under this condition, the hinge housing 101 and hinge shaft 103 are rotatably coupled so that the housings 201 and 202 face each other.

The elastic means 104 is received in the hinge housing 101 to provide an elastic force that brings the hinge cam 102 into contact with the hinge shaft 103. Preferably, the elastic means 104 comprises a compression coil spring having one end supported by the first support rib 115 and the other end supported by the second support rib 125. The elastic force of the compression coil spring is applied to the hinge cam 102 to bring the hinge cam 102 into contact with the hinge shaft 103.

The housing cap 105 is fixedly mounted to one end of the hinge housing 101. One or more second fastening members 151 corresponding to the first fastening members 113 are provided at an outer peripheral surface of the housing cap 105 to provide a fastening means for the housing cap 105 and hinge housing 101 in cooperation with the first fastening members 113. The first fastening members 113 and second fastening members 151 are coupled by fasteners such as screws 159 in a state of being aligned with each other. When the housing cap 105 is fastened to the hinge housing 101, the coupling member 133 of the hinge shaft 103 protrudes beyond the hinge housing 101 and the step 137 of the hinge shaft 103 is in contact with the housing cap 105. Thus, the housing cap 105 prevents the hinge cam 102, hinge shaft 103, and elastic means 104 from being separated from the hinge housing 101. An engagement rib 153 is provided at an inner peripheral surface of the housing 105 to engage one of the guide grooves 111 at the inner peripheral surface of the hinge housing 101.

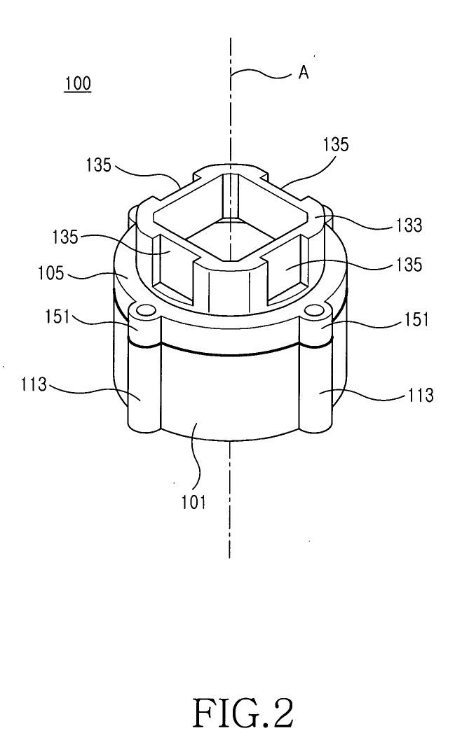

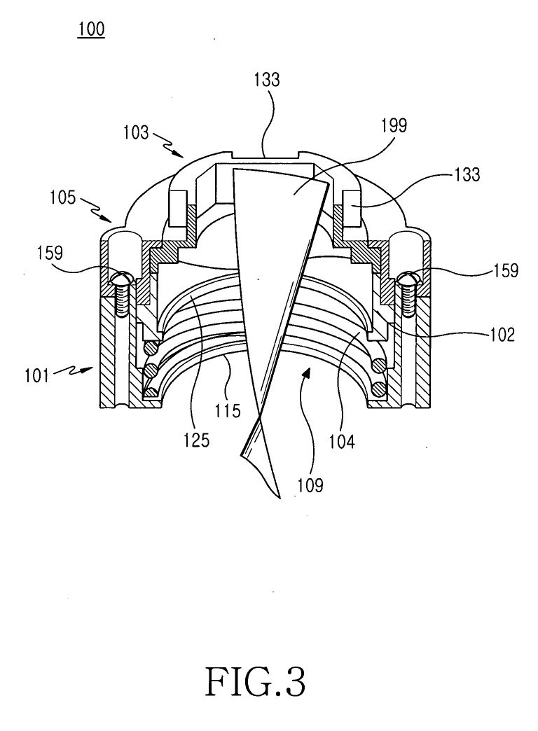

Referring to FIGS. 2 and 3, the hinge device 100 defines the wiring hole 109 extending longitudinally through the hinge device 100 in an assembled state of the hinge housing 101, hinge cam 102, hinge shaft 103, elastic means 104, and housing cap 105. The wiring hole 109 provides a space to accommodate a flexible printed circuit 100 that electrically connects circuit devices in the housings 201 and 202 of the terminal 200.

Hereinafter, the opening/closing operation of the portable terminal 200 according to the operation of the swing hinge device 100 having the above-described configuration will be described. In an initial state, the cam surface 131 of the hinge shaft 103 engages with the cam surfaces 121 of the hinge cam 121 such that the mountain and valley portions of the cam surfaces 121 and 131 engage each other. In this state, the resistance from the elastic means 104 is minimized. The second housing 202 overlaps the first housing 201, so that the second housing 202 is closed.

When the hinge shaft 103 is rotated from the initial state by an external force, the cam surface 131 of the hinge shaft 103 are disengaged from the cam surfaces 121 of the hinge cam 121 such that the mountain and valley portions of the cam surfaces 121 and 131 are disengaged from each other. As a result, the hinge cam 102 is moved away from the hinge shaft 103 against the elastic means 104, thereby causing the resistance from the elastic means 104 to increase gradually. The resistance from the elastic means 104 is proportional to the rotated angle of the hinge shaft 103.

When the external force applied to the hinge shaft 103 to rotate the hinge shaft 103 is released in the disengaged state of the cam surfaces 121 and 131, the hinge cam 102 is moved toward the hinge shaft 103 by the resistance force applied by the elastic means 104. As a result, the hinge shaft 103 is rotated in a direction causing the cam surfaces 121 and 131 to engage with each other. Thus, the resistance of the elastic means 104 rotates the hinge shaft 103 in the disengaged state of the cam surfaces 121 and 131.

When the hinge shaft 103 rotates through an angle less than 90° from the initial state, the resilience of the elastic means 104 functions to generate a drive force to move the hinge cam 102 toward the hinge shaft 103 such that the hinge shaft 103 is rotated to the initial state thereof.

When the hinge shaft 103 rotates through an angle greater than 90° from the initial state, the resilience of the elastic means 104 functions to move the hinge cam 102 toward the hinge shaft 103 such that the hinge shaft 103 is rotated by 180°. As a result, the second housing 202 is rotated 180° with respect to the first housing 201, so that the second housing 202 is completely opened.

While this invention has been described in connection with what is presently considered to be the most practical and preferred embodiment, it is to be understood that the invention is not limited to the disclosed embodiment, but, on the contrary, it is intended to cover various modifications within the spirit and scope of the appended claims.

What is claimed is:

1. A swing hinge device of a portable terminal for rotatably coupling a pair of housings included in the portable terminal while maintaining the housings facing each other, comprising:
a hinge housing;
a hinge cam received in the hinge housing to perform a linearly reciprocating movement in a longitudinal direction of the hinge housing in accordance with a predetermined elastic force applied to the hinge cam;
a hinge shaft received in the hinge housing to face the hinge cam and to be rotatable about a hinge axis extending in the longitudinal direction of the hinge housing; and
a housing cap fixed to one end of the hinge housing to confine the hinge cam and the hinge shaft in the hinge housing whereby the hinge shaft partially protrudes from the housing cap,
the hinge cam and the hinge shaft defining a wiring hole extending throughout the hinge housing in the longitudinal direction of the hinge housing while the housing cap is fixed to the hinge housing.

2. The swing hinge device according to claim 1, further comprising:
at least one first fastening member provided at an outer peripheral surface of the hinge housing to extend in the longitudinal direction of the hinge housing so as to protrude radially from the outer peripheral surface of the hinge housing; and
at least one second fastening member provided at an outer peripheral surface of the housing cap, the at least one second fastening member corresponding to the at least one first fastening member.

3. The swing hinge device according to claim 1, further comprising:
a first cam surface formed at one end of the hinge cam, the first cam surface having first alternating mountain and valley portions;
a second cam surface formed at one end of the hinge shaft to be engagable with the first cam surface, the second cam surface having second alternating mountain and valley portions respectively corresponding to the first mountain and valley portions of the first cam surface;
elastic means to provide an elastic force to bring the hinge cam into contact with the hinge shaft,
whereby the elastic force of the elastic means is converted, in response to a rotation of the hinge shaft, to a force to rotate the hinge shaft in a direction causing the first and second cam surfaces to be engaged with each other.

4. The swing hinge device according to claim 3, further comprising:
a first support rib formed on an inner peripheral surface of the hinge housing at a lower end of the hinge housing to extend in a circumferential direction of the hinge housing;
a second support rib formed on an inner peripheral surface of the hinge cam to extend in a circumferential direction of the hinge cam,
wherein the elastic means has one end to be supported by the first support rib, and the other end to be support by the second support rib.

5. The swing hinge device according to claim 1, further comprising:
at least one guide groove formed at an inner peripheral surface of the hinge housing to extend in the longitudinal direction of the hinge housing; and
a guide protrusion formed at an outer peripheral surface of the hinge cam to linearly move in the guide groove.

6. The swing hinge device according to claim 5, wherein:
the guide groove extends to one end of the hinge housing; and
the swing hinge device further comprises an engagement rib formed at one end of the housing cap to be engaged with the guide groove.

7. The swing hinge device according to claim 1, wherein a flexible printed circuit to electrically connect circuit devices respectively carried in the housings of the portable terminal extends through the wiring hole.

8. The swing hinge device according to claim 1, further comprising:
at least one coupling groove formed on an outer peripheral surface of the hinge shaft at a portion of the hinge shaft protruding from the housing cap.

9. The swing hinge device according to claim 2, wherein the housing cap is fixed to the hinge housing by a screw to be fastened to the first fastening member of the hinge housing and the second fastening member of the housing cap.
